(19) United States
(12) Patent Application Publication
(10) Pub. No.: US 2015/0342330 A1
(43) Pub. Date: Dec. 3, 2015

(54) Paddle Clip

(71) Applicant: Calvin Frederic Tom, Cardiff, CA (US)

(72) Inventor: Calvin Frederic Tom, Cardiff, CA (US)

(21) Appl. No.: 14/292,803

(22) Filed: May 30, 2014

(51) Int. Cl. A45F 5/02; F16B 2/24; B63H 16/04; F16B 2/22

(52) U.S. Cl. CPC A45F 5/021; F16B 2/22; F16B 2/245; F16B 2/248; B63H 16/04

(57) ABSTRACT

A paddle clip that is attached to a belt that secures the paddle. The paddle clip is elongated to receive the paddle shaft into a trough that uses the back plate of the clip to keep the paddle shaft in the trough. In addition, the paddle can be secured and removed with one hand.

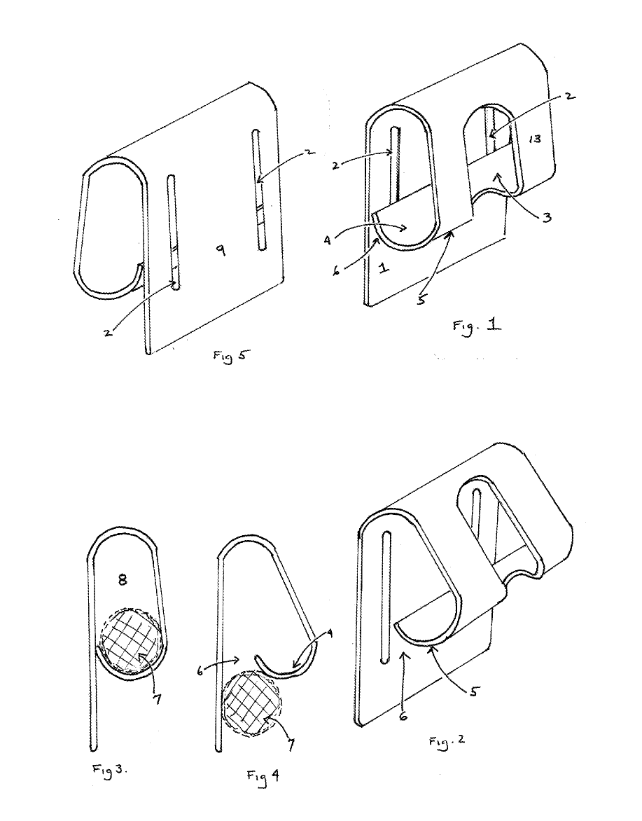

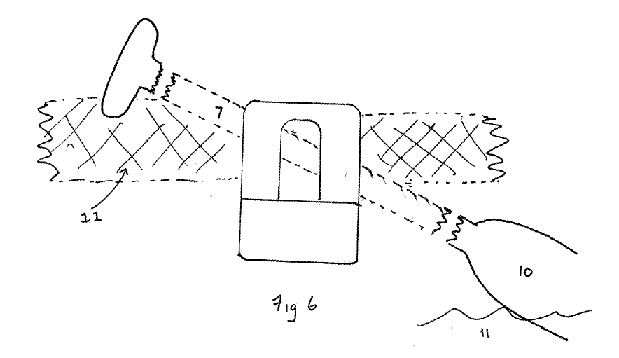

### BACKGROUND OF THE INVENTION

1. Field of the Invention

The present invention relates to an article of manufacture or a clip to securely hold a paddle hands free on the belt of a person stand up paddling on a standup paddle board, boat, kayak, surfboard or any watercraft on which they may be fishing, bird watching, hunting, taking pictures or other such activities that would require the use of both hands and at the same time provide quick and easy access of the paddle to resume paddling, and for safety.

2. Description of Prior Art

A paddle for use while standing on a kayak, canoe or standup paddle board is comprised of an elongated shaft having a first end and a second end, at least one end of the shaft having a blade attached thereto and the other end a handle or grip or another blade.

Current clips are not designed to hold the paddle on a belt while standing. My instant invention will hold the paddle securely on a waist belt, allow one hand storage and access, and allow quick access for safety and convenience.

The current paddle clips are designed to attach to the watercraft and in many cases causes the person while stand up paddling to either kneel, sit or awkwardly bend down to secure the paddle and retrieve the paddle. U.S. Pat. No. 7,527,012 B2, issued May 5, 2009 to Kutny Splaine teaches a paddle clip having a paddle clip that is mounted to the gunwale or cockpit rim of the watercraft. Further, Splaine does not teach the need for a paddle clip while standing, or the importance of multiple positioning of the paddle in the clip that is necessary for the standup paddler or the quick one hand storage and retrieval of the paddle for convenience and safety.

There are many belt accessories and specialty belts with pouches and holders for holding sporting gear, camera gear and fishing gear. An as an example there are many fishing pole holders on the market that allow fishermen to secure their rods in a belt rod holster, such as U.S. Pat. No. 6,805,270 B1 dated Oct. 19, 2004. The various pole holders are used to free up the hands for fishing, but none address the current problem of how to secure the paddle first to free up the hands so that the fishing pole holder may be used. The fishing pole holder only takes care of one half of the problem of using both hands. My invention takes care of the first, freeing the hands to use the pole holder for the necessary actions of fishing. Another example is a photographer using a standup paddleboard. The photographer may need to adjust the camera settings, change lenses, clean the lens, and ultimately take pictures, all requiring the use of both hands while standing without the paddle encumbering his hands. The same holds true for using binoculars for bird watching. Even if the binoculars were around the paddler's neck, for comfort and use of the binoculars the hands should be freed from the paddle. These are but a few of many examples of this feature of my invention.

Another very important feature of my invention is that the storage of the paddle can be done quickly so that opportunities are not missed. Examples are, casting a fishing pole where the fish are present, take a photo of wildlife before they move, or take aim while bow hunting.

In addition, it is very important for safety that the paddle can be retrieved quickly and easily to avoid collision with objects in the water such as branches, rocks, water plants, and trees as well as objects on shore such as trees, plants, boulders, rocks and steep embankments and the shore itself as well as shallow water where the watercraft could become stuck. All these conditions and others are potentially harmful to the paddler and require the ability to retrieve the paddle quickly for safety.

Also, being able to retrieve the paddle easily is important so that the stand up paddler does not fall into the water due bending, stooping, over reaching for the paddle or the unstable nature of standing on a watercraft.

Also, it is important that the paddle can be retrieved quickly for maneuvering the watercraft into the best fishing, viewing, hunting or photographic position and location.

All of the above mentioned problems and safety issues are addressed and are features and objectives of my instant invention.

No current patents take into consideration singularly or in combination what is described and claimed in my instant invention.

### SUMMARY

The present invention is a paddle clip that can be attached to a belt to secure a paddle of a standup paddler while in the standing position to free up his hands. The clip has features to 1. allow one hand use to secure and retrieve the paddle, 2. move the paddle into multiple positions as necessary to facilitate comfort for the use of hands and body movement, and 3. quick and easy access.

In accordance with the invention a paddle clip comprised of one piece of sheet plastic, or a laminate or sheet metal with a substantially elongated shape having a back plate and a flexible resilient clip portion with an opening configured for accommodating a cylindrical shaft of a paddle in a parallel position with the shaft with an elongated trough to accommodate the paddle shaft with an opening of the clip portion having a flared opening to facilitate squeezing the shaft into the clip with one hand. In addition, using only one hand, the fingers can lift open the clip and at the same time the body of the clip has a second opening large enough for thumb or finger to press downward to release paddle shaft onto the fingers of the same hand. The body of the clip also has a back plate that is part of the clip that works in conjunction with the clip to force the center point of the curve of the paddle shaft to rest in the trough of the clip.

The preferred version is fabricated out of a plastic that allows flexibility of the clip while being stiff enough to secure the paddle. The use of molded or sheet plastic would allow for inexpensive production, however, the clip could be manufactured out of sheet metal, wire or laminates.

Accordingly it is a principle object to provide a convenient method for a standup paddler to secure his paddle while standing for safety thus eliminating the need to stoop, kneel, bend or end up in an awkward position to set the paddle down or clip a paddle into a holder on a watercraft.

Another objective is to provide the ability to secure and retrieve the paddle with one hand for convenience and safety.

Another objective is to provide the ability of the paddler to rest either end of the paddle on the deck of the watercraft or in the water, or balance the paddle completely in the paddle clip.

Another objective is to allow a paddle to be slid in any number of positions along the trough of the paddle clip for convenience and safety. This allows for body movement such as sitting and for moving the paddle out of the way of objects, and for convenient use the use of the hands.

Another objective is to allow the clip to be used any where on a belt, at the front, side or back to accommodate whatever is the most comfortable position for the paddler.

Another objective is to provide an extremely secure attachment of the paddle at the same time having it easily accessible and positionable. When performing other task such as fishing, photograph or hunting while stand up paddling, winds, rough weather conditions, rough seas, bumping the paddle with hands or other objects could knock the paddle out of the clip if it were not extremely secure, thus if it were not extremely secure a very dangerous situations could occur where the paddle ends up in the water leaving the paddler without his main means of guidance and propulsion.

Another objective is to provide a paddle clip that can be used on belts manufactured for various sports including fishing, photography, hunting and bird watching without exclusivity to any one sport or for use by itself on a general purpose belt.

### DETAILED DESCRIPTION OF THE PREFERRED EMBODIMENTS

The present invention is a belt paddle clip comprised of a shingle sheet of plastic material between 1/16 inch to ¼ inch thick. The clip is comprised of a flat 1) back plate a rounded top a flat 13) front and a rounded bottom that creates a 4) trough with the open end of the trough facing the 1) back plate creating the opening for the clip. The thickness and properties of the plastic will allow the clip to spring back to its original shape. The diameter of the curve at the top and the curve at the bottom are roughly the size of a 7) paddle shaft that it will accommodate. The curve at the bottom in the 13) front of the clip forms the 4) trough that the paddle rests in. The 13) front of the paddle clip and the 1) back plate are substantially parallel. The vertical height of the 8) interior of the clip that holds the paddle shaft is between 1 and 2½ times the diameter of the paddle shaft. The 3) thumb opening at the 13) front of the paddle clip is large enough to accommodate a persons thumb approximately 1¼ inch wide or wider and the vertical length will extend roughly from the bottom of the top curve down to the bottom of the 4) trough. The 1) back plate will extend beyond the bottom of the front of portion of the clip approximately 1 and ½ inches.

The opening of the clip will be the open edge of 4) trough portion of the clip, closed the clip will have enough closed pressure to keep a paddle shaft held over the 4) trough. The 4) trough will extend at least up to the mid point of its curve to hold a paddle shaft in place.

The overall width of the clip is between 2 to 5 inches and overall height is between 1½ inches and 4 inches. The overall height of the 13) front portion of the clip is between 1¼ and 3 inches.

It is to be understood that the present invention is not limited to the embodiments described above, and encompasses any and all embodiments within the scope of the following claims.

I claim:

1. A belt paddle clip comprising: a clip comprising: a substantially elongated shape having a back plate and a flexible resilient clip portion with an opening configured for accommodating a cylindrical shaft of a paddle in a parallel position with the shaft, wherein the clip has a substantially parallel elongated trough to accommodate the shaft of the paddle, wherein the opening of the clip portion at the bottom of the trough has a rounded entry point that is oriented to facilitate the use of one hand to squeeze the shaft into the clip, wherein the body of the clip has a backing plate that works in conjunction with the clip to force the center point of the curve of the paddle shaft that is parallel to the back plate to rest in the trough of the clip, wherein the bottom of the clip made up by the bottom of the trough can be lifted away from the back plate thereby allowing the paddle to fall towards the opening and be released from the clip.

2. The belt paddle clip in claim 1 having a slot, hole or opening large enough for a thumb to press downward to assist in releasing the paddle.

3. The belt paddle clip in claim 1 having means for securing the paddle clip to a belt by slots in the back plate.

4. The belt paddle clip in claim 1 having means to permanently attach the back plate by sewing, rivets or other know attachment methods to a belt.

5. The belt paddle clip in claim 1 having means to temporarily attach to a belt by having slots or clip on the back plate.

6. The belt paddle clip in claim 1 being made of PVC, ABS or other plastics, sheet metals, spring steel metals, laminates or wire.

7. The belt paddle clip in claim 1 covered in a cloth or webbing materials with means to attach to a belt.

8. The belt paddle clip in claim 1 having a trough that allows the paddle shaft to be slid along the trough so as to quickly and easily rest either end of a paddle in the water, on the deck of the watercraft or other location, or balance the paddle completely out of the water.

9. The belt paddle clip in claim 1 wherein the paddle is held securely in the trough and will not fall out.

10. The belt paddle clip in claim 1 wherein the paddle clip can be secured in the clip using only one hand by squeezing the paddle shaft into the clip

11. The belt paddle clip in claim 1 wherein the paddle can be released by using only one hand by pulling open the body of the clip at the bottom of the trough with fingers and by inserting the thumb into a slot in the body of the clip placing pressure on the shaft to push the paddle shaft out of the clip into the same hand.

12. The belt paddle clip in claim 1 wherein the trough is sized to allow the back plate to push the center of the shaft that is parallel to the back plate to rest in the trough of the clip.
